(19) United States
(12) Patent Application Publication
(10) Pub. No.: US 2008/0071950 A1
(43) Pub. Date: Mar. 20, 2008

(54) THIN CLIENT IMPLEMENTATION BASED ON REDIRECTION OF VIRTUAL I/O DEVICES

(75) Inventor: Bradley Justice, Richmond, CA (US)

Correspondence Address: HISCOCK & BARCLAY, LLP, 2000 HSBC PLAZA, 100 Chestnut Street, ROCHESTER, NY, 14604-2404, US

(73) Assignee: Ithaca Technologies, LLC, Ithaca, NY (US)

(21) Appl. No.: 11/857,886

(22) Filed: Sep. 19, 2007

Related U.S. Application Data
(60) Provisional application No. 60/845,691, filed on Sep. 19, 2006.

(51) Int. Cl. G06F 13/00

(52) U.S. Cl. 710/100

(57) ABSTRACT

The invention relates to a system for transferring media content on a network including a hardware device. The hardware device is configured to be connected to a network. The hardware device also includes at least one I/O interface and at least one user interface I/O. The system also includes a computer configured to be communicatively connected to the hardware device via the computer network. Installed software on the computer includes one or more virtual devices and supervisor software. The supervisor software starts at least one media software package suitable to perform the user requested media transfer between the hardware device and the computer via the one or more virtual devices. Another aspect of the invention relates to a method of transferring a media file between a remote hardware device and a computer.

### CROSS-REFERENCE TO RELATED APPLICATIONS

This application claims priority to and the benefit of co-pending U.S. provisional patent application Ser. No. 60/845,691, filed Sep. 19, 2006, entitled “A THIN CLIENT IMPLEMENTATION BASED ON REDIRECTION OF VIRTUAL I/O DEVICES” the disclosure of which application is incorporated herein by reference in its entirety.

### FIELD OF THE INVENTION

This invention relates generally to a system and method for remote access to media content and more particularly to a system and method for remote user access to audio and/or video media content from a computer on a network.

### BACKGROUND OF THE INVENTION

Digital media such as audio, video, and photographs are commonly stored on network-accessible storage locations. Network-accessible storage locations can include computers having storage or network-attached storage (NAS) devices. Stored media can be recorded, transferred, and played back using a computer. Increasingly media is also accessed for playback using a less powerful computing device commonly called a media player. One advantage of media players is that the media can be accessed from locations where a standard computer is not present.

While usually less powerful than a standard computer, media players still require substantial computing power including a fast enough central processing unit (CPU) and large enough computer memory to initiate access to the stored media and to decode the media. In addition, there are many stored media and digital rights management (DRM) formats. In order to decode and present all media stored on the network, media players require software and/or hardware to decode each encoding and DRM scheme. The decoding process can require both a significant amount of software and significant processing power. In addition, commercial licensing restrictions may preclude the embedding of software or hardware required to decode and present all of the media content stored on the network.

Typically there is a network attached computer with both the computing and decoding capability to present all of the digital media stored on the network. Any media player attached to the network duplicates this capability, often with reduced functionality resulting from the device containing a subset of the required decoding capability. Therefore, what is required to minimize device cost while maximizing media compatibility is a system and method to perform media decoding on a network attached computer while presenting decoded media to a remote device.

### SUMMARY OF THE INVENTION

In one aspect, the invention relates to a system for transferring media content on a network including a hardware device including a network connection. The hardware device is configured to be connected to the network via the network connection. The hardware device also includes at least one I/O interface and at least one user interface I/O. The system also includes a computer configured to be communicatively connected to the hardware device via the computer network. The computer is configured to run an installed software. The installed software includes one or more virtual devices and a supervisor software. The supervisor software is configured to interpret a user requested media transfer command sent to the hardware device via the user interface I/O and the supervisor software is configured to start at least one media software package suitable to perform the user requested media transfer between the hardware device and the computer via the one or more virtual devices.

In one embodiment, the decoding of the media content is performed by the at least one media software package running on the computer.

In another embodiment, the decoding of the media content includes decoding of media content including digital rights management (DRM) encoding.

In yet another embodiment, the decoding of the media content includes decompression of compressed media content.

In yet another embodiment, the hardware device is embedded in an audio component.

In yet another embodiment, the hardware device is embedded in a video component.

In yet another embodiment, the hardware device includes an audio interface and the virtual device includes a logical connection to a hardware component external to the hardware device.

In yet another embodiment, the hardware component includes an audio player.

In yet another embodiment, the hardware device includes a video interface and the virtual device includes a logical connection to a hardware component external to the hardware device.

In yet another embodiment, the hardware component includes a television.

In yet another embodiment, the hardware component includes a video camcorder.

In yet another embodiment, the one or more virtual devices include at least one virtual controller configured to communicate with a component external to the hardware device and connected to the hardware device via a physical bus connection of the same type.

In yet another embodiment, the bus is a USB bus.

In yet another embodiment, the bus substantially conforms to an IEEE 1394 bus standard.

In another aspect, the invention features a method for transferring media content including the steps of providing a hardware device communicatively coupled to a computer network; accepting a request at the hardware device to transfer media content, transmitting the request to a network attached computer via the network, the network attached computer running software suitable to transfer the media content wherein the software is chosen by a supervisor program running on the computer; and transferring the media content between the network attached computer and the hardware device via a virtual device situated on the network attached computer.

In one embodiment, the method step for transferring media content of claim 11 further includes the step of decoding the media content between the steps of accepting a request at the hardware device and transferring the media content.

In another embodiment, the method step for transferring media content wherein the step of providing a hardware device includes providing a hardware device communicatively coupled to a computer network and an audio component connected to the hardware device, and the step of transferring the media content includes transferring the media content between the computer and the audio component via a virtual device situated on the computer.

In yet another embodiment, the step of providing a hardware device includes providing a hardware device communicatively coupled to a computer network and a video component connected to the hardware device, and the step of transferring the media content includes transferring the media content between the computer and the video component via a virtual device situated on the computer.

In yet another embodiment, the method step transmitting the request includes transmitting the request to a network attached computer via the network, wherein a supervisor software running on the network attached computer interprets the request and the network attached computer running software suitable to transfer the media content wherein the software is chosen by a supervisor program running on the computer.

In yet another aspect, the invention features a method of transferring a media file between a remote hardware device and a computer comprising the steps of: providing a network attached computer communicatively coupled to a network; receiving a request via said network by said network attached computer to transfer a media file to or from a hardware device; interpreting said request to transfer a media file by a supervisor software running on said network attached computer; starting by said supervisor software, in response to said request to transfer a media file, a suitable software package on said network attached computer to transfer said media file; as needed, encoding or decoding said media file using said suitable software package operating on said network attached computer; and transferring said media file to or from a physical device associated with said hardware device.

### BRIEF DESCRIPTION OF THE DRAWINGS

For a further understanding of these and objects of the invention, reference will be made to the following detailed description of the invention which is to be read in connection with the accompanying drawing, where:

FIG. 1 shows a block diagram of an exemplary hardware configuration according to the invention;

FIG. 2 shows a block diagram of one embodiment of a hardware device;

FIG. 3 shows block diagram of a hardware and software system according to the invention;

FIG. 4 shows a chart of data flow to and from a hardware device; and

FIG. 5 shows a chart illustrating an exemplary user request to play an audio file.

Drawings and diagrams are not necessarily drawn to scale.

### DETAILED DESCRIPTION OF THE INVENTION

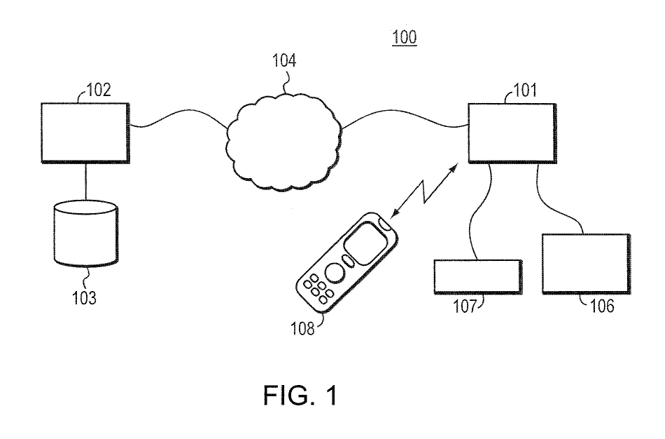

Hardware suitable for a system 100 and method according to the invention is shown in FIG. 1. A network attached computer 102 having storage 103 can be connected directly or indirectly to a network 104. Network 104 can be a local area network, intranet, or the Internet. A hardware device 101 can also be coupled directly or indirectly to network 104. Both network attached computer 102 and hardware device 101 can be connected to a network via a wired or wireless router (not shown in FIG. 1), or other suitable intermediate network connection device. Hardware device 101 can be a stand alone unit having audio input/output capability as an internal speaker and/or earphone jack (not shown) and/or a display screen for displaying video and/or a microphone and/or a video camera. Hardware device 101 can also have one or more audio and/or video signal connections to other equipment, such one or more an audio component including, but not limited to, a home stereo or home theatre unit and/or one or more video components, including television (TV) sets and camcorders. Hardware device 101 can also include a display and mechanical or electronic keys, buttons, and/or knobs for user interaction with the supervisor program running on a network attached computer 102. Hardware device 101 can also (or alternatively) include a remote control 108 for user interaction with a supervisor program running on a network attached computer 102. Remote control 108 can be communicatively coupled to hardware device 101 by light, such as infrared (IR) light, radio, or by other wireless methods including a wired or wireless connection (not shown).

In other embodiments, it is contemplated that hardware device 101 can be embedded into an electronic component, such as embedded in a television set. Where hardware device 101 is used in an embedded application, such as in a TV, interaction with the supervisor program running on a network attached computer 102 can be via controls on the TV or more typically via a TV or universal remote control having keys and/or a display. The TV can also serve as a display for user I/O interaction with hardware device 101.

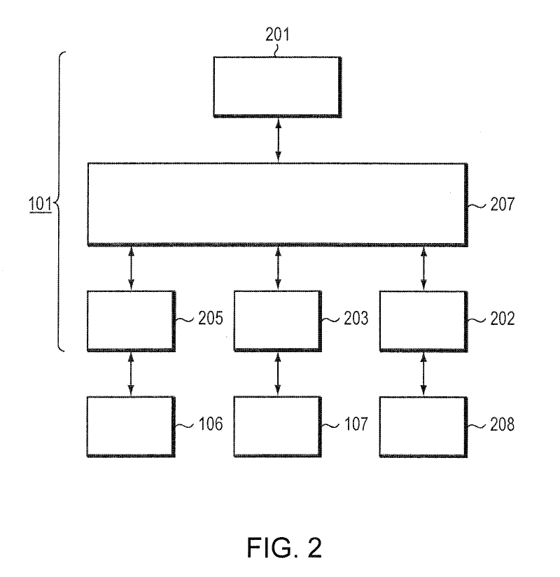

FIG. 2 shows a block diagram of one embodiment of hardware device 101. Network interface 201 can be a wired or wireless network interface. Processor 207 can typically be a microprocessor, microcomputer, or other suitable programmable logic component that can perform the functions of a microcomputer, such as a field programmable gate array. User input/output interface block 202 allows processor 207 to communicate with the supervisor program running on a network attached computer 102 using a user I/O component (208), such as remote control 108. Audio interface and I/O block 203 can be connected to one or more external audio components 107 to play audio sent to the one or more external audio component 107 from network attached computer 102 via hardware device 101 and/or to record audio provided from the one or more external audio components 107. Video interface 205 can be connected to one or more external video components 106 to play video sent to the one or more external video components 106 from network attached computer 102 via hardware device 101 and/or to record video from the one or more external video components 106. As shown in FIG. 2, external audio connections can include, but are not limited to analog stereo connections, and digital audio connections. External video connections can include, but are not limited to analog video, RGB, and any of the various implementations of HDMI (High Definition Multimedia Interface) and DVI (Digital Video interface). In embodiments using hardware device 101 in an embedded application, external connections for audio and video can be via typical external audio video I/O such as those found on many TV sets.

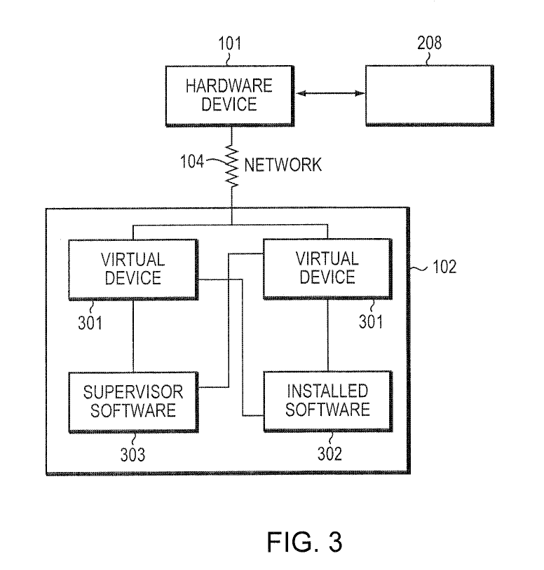

The operation of the inventive system and method is now explained using the system diagram shown in FIG. 3. As previously discussed, hardware device 101 can be connected to network attached computer 102 via network 104. An important aspect of the invention is that decoding of media content is accomplished by installed software 302 running on network attached computer 102. Another important aspect of the invention is that supervisor software 303, also running on network attached computer 102, can determine which installed software 302 program to run for any given selection or request generated by user interface 202. Such selection can be made from one or more menus generated by supervisor software 303 and communicated to a user via user interface 202. Once a selection is playing (or being recorded), supervisor software 303 can cause full or partial screens or information derived from a particular installed software 302 playing (or recording) user requested audio and/or video media content.

Since in most preferred embodiments, all media decoding is done by the installed software 302 that is running on network attached computer 102 to provide (or record) user requested audio and/or video media content, there is only a relatively light computational demand on processor 207. Therefore, processor 207 only needs sufficient computational power to convey already decoded audio and/or video to the appropriate interface 203 and/or 205 (FIG. 2) for playing audio and/or displaying video signals. Generally only raw decoded audio in a PCM or similar decoded audio format and video in a bit map or MPEG or similar decoded video format are sent to (or received from) hardware device 101. Similarly, user interface 202 performs only minimal I/O using one or more displays and keypads to merely display information presented to it by supervisor software 303 including optional screens, partial screens, or other information from installed software 302 displayed under control of supervisor software 303. Therefore, processor 207 needs only a minimal computation capability to display screens and convey other user I/O 202 since substantially all software decisions and actions based on user I/O 202 are made by supervisor software 303. Exemplary installed software 302 can include programs such as iTunes™ or Window Media Player™ and other well known third party audio and video recording, editing, and playback software packages with or without DRM capability as needed. Communication of decoded signals with hardware device 101 can be accomplished by one or more virtual device drivers as shown by virtual device 301. Supervisor software 303 selects and activates the one or more virtual devices 301 based on a chosen user playback (or record) device and a particular installed software 302 choice appropriate to satisfy a given user request. Virtual devices 301 can include a virtual USB or Firewire™ (IEEE 1394) virtual controller that ultimately controls a physical USB or Firewire connected component to a hardware device 101. For example, where supervisor software 303 has been programmed to accommodate certain models of video camcorders, supervisor software 303 can download or record video to (or from) network attached computer 102 to (or from) a USB or Firewire attached video camcorder. Virtual devices 301 are not, however, necessarily associated with any plug in audio and/or visual component. Virtual devices 301 can also be used to exchange audio and/or video between network attached computer 102 and hardware device 101, such as in a case where hardware device 101 includes one or more internal amplifiers and one or more speakers in an embodiment where hardware device 101 can be a stand alone audio player.

It can now be seen that the inventive system and method utilizes the computing power and decoding capability of a network attached computer 102 to access and decode stored digital media to a format that can be played (or recorded) by a hardware device 101. After decoding by installed software 302 running on the network attached computer 102, the digital audio and/or video media can be transmitted across the network in a decoded format that is compatible with the audio and video hardware embedded in or attached to a remote hardware device 101. No further processing is required by hardware device 101. Hardware device 101 can also be viewed as a data conduit that presents decoded data to embedded or attached video and/or audio playback/record hardware. A similar process can occur for the recording of digital video and/or audio media. The audio and/or video hardware embedded or attached to hardware device 101 can encode an analog audio and/or video input in its native format. In preferred embodiments, hardware device 101 provides no additional encoding nor does it attempt to store the incoming digital information within hardware device 101. Instead, hardware device 101 transmits the media in its native format to a network attached computer 102 where the data can then be further encoded into a desired format and stored at a target location by software running on network attached computer 102. Supervisor software 303 can be used to select appropriate installed software 302 for encoding raw digital media sent from a hardware device 101.

In order to further simplify hardware device 101, input from a user and output to the user can be processed by network attached computer 102 rather than on hardware device 101. User instructions for the operation of hardware device 101 can be passed from an attached input source, in its native format, to a network attached computer 102 for further processing, including optional encoding. Only the minimal processing needed to transmit the digital media data is typically performed on hardware device 101. Software running on a network attached computer 102 can process a user input and initiate the requested actions. Similarly, software running on network attached computer 102 can generate output to the user in a format directly usable by one of more output hardware components attached to or housing an embedded hardware device 101. Hardware device 101 can pass the digital data directly to the attached or embedded remote device without further processing.

A system and method according to the invention can be seen to generally include three elements: (1) one or more hardware devices 101, (2) one or more virtual hardware devices such as virtual devices 301 on one or more network computers 102, and (3) a supervisor software 303 running on the network attached computer 102.

1. Hardware device: Hardware device 101 can include attached or embedded input and output devices and can be attached to one or more networks 104. Network 104 can be a standard network such as those networks defined by Institute of Electrical and Electronics Engineers (IEEE) industry specifications or network 104 can be some other type of proprietary network. Hardware device 101 can accept input audio and/or video media data from one or more attached input sources of audio and/or video digital media and transmit the data to a network attached computer 102 via a network 104. Only minimal processing is needed by hardware device 101 to transmit the data accepted for recording by the device. Hardware device 101 can also receive decoded audio and/or video media data from the network attached computer 102 and pass it to one or more appropriate output devices. Again, only minimal processing by hardware device 101 is needed to receive the data from a network attached computer 102 and to pass it one or more output devices.

2. Virtual Devices: One or more virtual hardware devices, such as virtual devices 301 on one or more network attached computers 102 act as software entities that can emulate a physical hardware device. Software running on a network attached computer 102 can address virtual devices 301 as if it was the physical device being emulated, without the knowledge that a physical device is not truly present. Input data from hardware device 101 can be transmitted via a network 104 to one or more of these virtual devices 301 located on a network attached computer 102. Output directed to these virtual devices 301 can then be transmitted via network 104 to one or more hardware device 101. Thus, there can be a logical attachment between a virtual device 301 and one or more of the physical devices embedded in or connected to the hardware device 101. When software running on a network attached computer 102 passes data to a virtual device 301, virtual device 301 can transmit the data via a network 104 to one or more hardware devices 101. Hardware devices 101 can then pass the digital media data to an appropriate embedded or attached physical device. When a hardware device 101 receives data from an attached or embedded physical device, it can transmit the digital media data via network 104 to an appropriate virtual device 301.

A virtual device 301 can be implemented as: a) a virtual data bus such as a Universal Serial Bus (USB) or Firewire data bus; b) a collection of one or more virtual input and output devices (e.g. a virtual video device, a virtual audio device, and a virtual serial port device); or c) some combination of a and b. Where a virtual device 301 is implemented as a virtual data bus, the physical mapping can be between a physical bus on the hardware device 101 and a virtual bus on a network connected computer 102 or a virtual bus on a hardware device 101 and a virtual bus on a network attached computer 102.

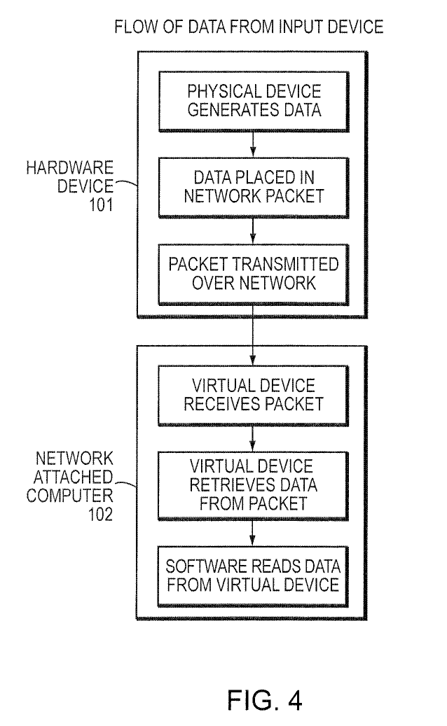

FIG. 4 shows a chart of an exemplary flow of data from an input device (attached to a hardware device 101) to software running on a network attached computer 102. In this example virtual device 301 is a virtual input device. A similar process can occur for passing data from software on a network attached computer 102 to a hardware device 101. Returning to FIG. 3, virtual device 301, supervisor software 303 and installed software 302 are software entities can be executed on a network attached computer 102. There can be one or more virtual devices 301. There can also be one or more installed software applications 302.

3. Supervisor Software: A supervisor software 303 runs on the network attached computer 102. The supervisor program receives user input from the hardware device (1) through a virtual hardware device (2). Typically digital media is stored in a variety of formats that may also utilize different DRM encoding schemes. In order to record or play back all of the digital media stored on the network, more than more installed software 302 provided by more than one software or hardware vendor is usually used. Supervisor software 303 can invoke the appropriate installed software 302 to record or play back the digital media and passes it the appropriate commands to implement the user request. Supervisor software 303 can also direct media output from installed software 302 to a user requested playback component, such as audio and or video components 106 or 107. Optionally supervisor software 303 can provide output to the user regarding an internal state of supervisor software 303, or the state of invoked installed software 302, by sending it to a virtual device 301 where it can be transmitted over the network to hardware device 101 for display on a user viewable display screen.

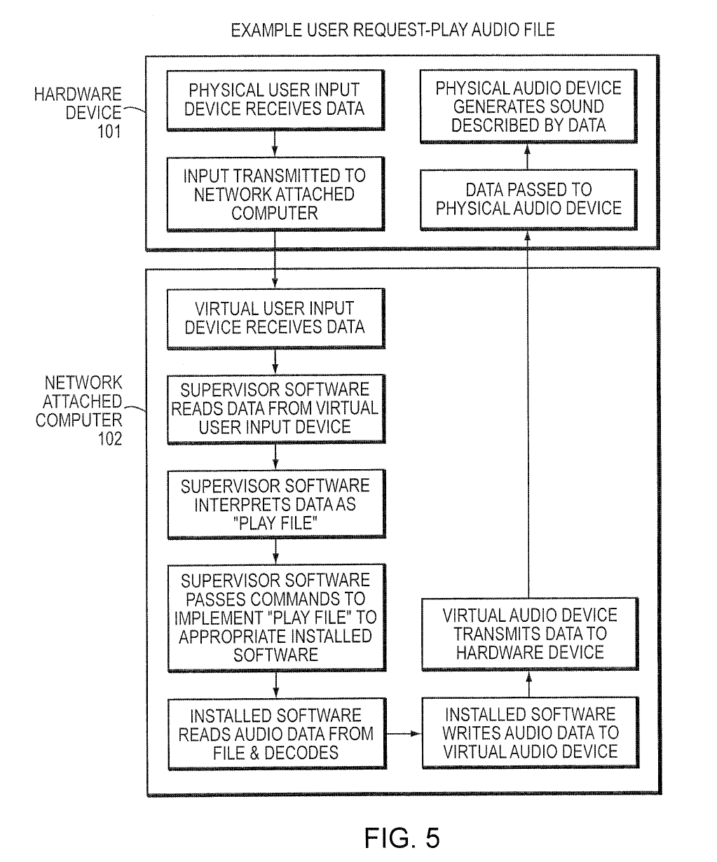

FIG. 5 shows an example of the processing of a user request for an audio file. Note that the processing steps performed by installed software 302 are performed by an operating system component or third party application that is typically not provided as part of the invention. Installed software 302 is generally an external resource provided by, and running on, a network connected computer 102. Installed software 302 can include an operating system component and/or a third party application. The ability of the invention to make use of these installed software resources and the processing resources of a network connected computer 102 to run supervisor software 303 and installed software 302 is an important aspect of the invention.

In summary, a system and method according to the present invention permits the playback, recording and/or transfer of digital audio and/or video available on a network. Hardware device 101 need not have the processing capability or software necessary to encode or decode the digital media. Moreover, hardware device 101 does not need the ability or access rights to read from or write to a storage location. Also, the operating system or application software installed on a network attached computer 102 need not be designed to support a hardware device 101, since interaction between an operating system and/or installed application software can be coordinated by supervisor software 303

While most commonly media content can be transferred to or from the hardware device, it also contemplated that media content could be transferred simultaneously in both directions between a network attached computer and the hardware device as described herein.

While the present invention has been particularly shown and described with reference to the preferred mode as illustrated in the drawing, it will be understood by one skilled in the art that various changes in detail may be effected therein without departing from the spirit and scope of the invention.

We claim:

1. A system for transferring media content on a network comprising:
a hardware device including a network connection, said hardware device configured to be connected to said network via said network connection, said hardware device also including at least one I/O interface and at least one user interface I/O; and
a computer configured to be communicatively connected to said hardware device via said computer network, said computer configured to run an installed software, said installed software including one or more virtual devices and a supervisor software, said supervisor software configured to interpret a user requested media transfer command sent to said hardware device via said user interface I/O and said supervisor software configured to start at least one media software package suitable to perform said user requested media transfer between said hardware device and said computer via said one or more virtual devices.

2. The system of claim 1 wherein decoding of said media content is performed by said at least one media software package running on said computer.

3. The system of claim 2 wherein decoding of said media content comprises decoding of media content including digital rights management (DRM) encoding.

4. The system of claim 2 wherein decoding of said media content comprises decompression of compressed media content.

5. The system of claim 1 wherein said hardware device is embedded in an audio component.

6. The system of claim 1 wherein said hardware device is embedded in a video component.

7. The system of claim 1 wherein said hardware device comprises an audio interface and said virtual device comprises a logical connection to a hardware component external to said hardware device.

8. The system of claim 7 wherein said hardware component comprises an audio player.

9. The system of claim 1 wherein said hardware device comprises a video interface and said virtual device comprises a logical connection to a hardware component external to said hardware device.

10. The system of claim 9 wherein said hardware component comprises a television.

11. The system of claim 9 wherein said hardware component comprises a video camcorder.

12. The system of claim 1, where said one or more virtual devices comprise at least one virtual controller configured to communicate with a component external to said hardware device and connected to said hardware device via a physical bus connection of the same type.

13. The system of claim 12, wherein said bus is a USB bus.

14. The system of claim 12, wherein said bus substantially conforms to an IEEE 1394 bus standard.

15. A method for transferring media content comprising the steps of:
providing a hardware device communicatively coupled to a computer network;
accepting a request at said hardware device to transfer media content;
transmitting said request to a network attached computer via said network, said network attached computer running software suitable to transfer said media content wherein said software is chosen by a supervisor program running on said computer; and
transferring said media content between said network attached computer and said hardware device via a virtual device situated on said network attached computer.

16. The method step for transferring media content of claim 15 further comprising the step of decoding said media content between the steps of accepting a request at said hardware device and transferring said media content.

17. The method step for transferring media content of claim 15 wherein the step of providing a hardware device comprises providing a hardware device communicatively coupled to a computer network and an audio component connected to said hardware device, and the step of transferring said media content comprises transferring said media content between said computer and said audio component via a virtual device situated on said computer.

18. The method step for transferring media content of claim 15 wherein the step of providing a hardware device comprises providing a hardware device communicatively coupled to a computer network and a video component connected to said hardware device, and the step of transferring said media content comprises transferring said media content between said computer and said video component via a virtual device situated on said computer.

19. The method step for transferring media content of claim 15 wherein the method step transmitting said request comprises transmitting said request to a network attached computer via said network, wherein a supervisor software running on said network attached computer interprets said request and said network attached computer running software suitable to transfer said media content wherein said software is chosen by a supervisor program running on said computer.

20. A method of transferring a media file between a remote hardware device and a computer comprising the steps of:
providing a network attached computer communicatively coupled to a network;
receiving a request via said network by said network attached computer to transfer a media file to or from a hardware device;
interpreting said request to transfer a media file by a supervisor software running on said network attached computer;
starting by said supervisor software, in response to said request to transfer a media file, a suitable software package on said network attached computer to transfer said media file;
as needed, encoding or decoding said media file using said suitable software package operating on said network attached computer; and
transferring said media file to or from a physical device associated with said hardware device.
